(19) United States
(12) Patent Application Publication
(10) Pub. No.: US 2014/0354567 A1
(43) Pub. Date: Dec. 4, 2014

(54) APPARATUS AND METHOD FOR OPERATING PROXIMITY SENSING FUNCTION IN ELECTRONIC DEVICE HAVING TOUCH SCREEN

(71) Applicant: Samsung Electronics Co., Ltd., Suwon-si (KR)

(72) Inventors: Chanhyoung PARK, Hwaseong-si (KR); Jeongho CHO, Suwon-si (KR)

(73) Assignee: Samsung Electronics Co., Ltd., Suwon-si (KR)

(21) Appl. No.: 14/291,790

(22) Filed: May 30, 2014

(30) Foreign Application Priority Data
May 30, 2013 (KR) 10-2013-0061880

(51) Int. Cl. G06F 3/041

(52) U.S. Cl. CPC G06F 3/0416
USPC 345/173

(57) ABSTRACT

A method and an apparatus for operating a proximity sensing function of an electronic device including a touch screen are provided. The electronic device detects a request for activating the proximity sensing function, and measures an illuminance value of light received by an illuminance sensor in response to the detected request. If the measured illuminance value is different from a predefined illuminance value, the device changes a threshold of the proximity sensing function, based on the measured illuminance value. The threshold is defined to determine whether an object is approaching the electronic device.

### CROSS-REFERENCE TO RELATED APPLICATION(S)

This application claims the benefit under 35 U.S.C. §119(a) of a Korean patent application filed on May 30, 2013 in the Korean Intellectual Property Office and assigned Serial number 10-2013-0061880, the entire disclosure of which is hereby incorporated by reference.

### TECHNICAL FIELD

The present disclosure relates to a proximity sensing function of an electronic device. More particularly, the present disclosure relates to an apparatus and method for operating a proximity sensing function based on the ambient illuminance environment.

### BACKGROUND

With recent advances in communication technologies, a great variety of mobile electronic devices such as a mobile phone, a smart phone, a tablet PC, and the like are increasingly popularized due to their high usability and good portability. These mobile electronic devices have now evolved into multimedia communication devices that offer various additional services such as a data transmission service as well as a traditional voice call service. Further, more convenient, intuitive and user-friendly user interfaces have been developed to cope with the increase of services available for such mobile electronic devices.

Meanwhile, a user who is on the phone may unintentionally touch the device with his or her body such as the face or ear. Especially, when a touch-sensitive device has a touch screen, this unexpected touch by a user may cause a wrong operation. Therefore, most of recent mobile electronic devices offer a function to prevent such a wrong operation due to a user's unexpected touch and thus to reduce power consumption, using a proximity sensor. For example, the proximity sensor recognizes the approach of a user and then executes a screen lock (or turn-off) function when the user is approaching, or executes a screen unlock (or turn-on) function when the user becomes distant.

Normally the proximity sensor has a light-emitting unit and a light-receiving unit. The light-emitting unit emits light, which is reflected by an object. Then the light-receiving unit absorbs the reflected light and thereby detects the approach of an object. Namely, the device having the proximity sensor creates data regarding the quantity of light received at the light-receiving unit and, based on such data, determines whether any object is approaching the electronic device.

When a certain proximity sensor includes an infrared sensor, the quantity of light absorbed at the light-receiving unit becomes higher than an actually measured value under a light source (e.g., sunlight) containing infrared light therein. Unfortunately, this often causes a wrong operation of the proximity sensing function in any ambient illuminance environment such as sunlight or indoor light. Therefore, there is a need for securing a normal operation of the proximity sensing function even in sunlight or the like.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a technique to effectively and reliably operate a proximity sensing function by adjusting the threshold of the proximity sensing function depending on the ambient illuminance environment.

In accordance with an aspect of the present disclosure, a method for operating a proximity sensing function of an electronic device including a touch screen is provided. The method includes detecting a request for activating the proximity sensing function, measuring an illuminance value of light received by an illuminance sensor in response to the detected request, and if the measured illuminance value is different from a predefined illuminance value, changing a threshold of the proximity sensing function, based on the measured illuminance value, wherein the threshold is defined to determine whether an object is approaching the electronic device.

In accordance with another aspect of the present disclosure, a method for operating a proximity sensing function of an electronic device is provided. The method includes detecting, at a main control unit, a request for activating the proximity sensing function, transmitting, at the main control unit, a sensor activation interrupt signal to a sub control unit, activating, at the sub control unit, an illuminance sensor in response to the sensor activation interrupt signal and collecting an illuminance value of light received by the illuminance sensor, and if the collected illuminance value is different from a predefined illuminance value, changing, at the sub control unit, a threshold of the proximity sensing function, based on the collected illuminance value, wherein the threshold is defined to determine whether an object is approaching the electronic device.

In accordance with another aspect of the present disclosure, an electronic device is provided. The electronic device includes a proximity sensor configured to emit light and to recognize an approach of an object by measuring a quantity of received light, an illuminance sensor configured to recognize a quantity of external light by measuring an illuminance value, and a control unit configured to detect a request for activating a proximity sensing function and, based on the measured illuminance value, to change a threshold of the proximity sensing function if the measured illuminance value is different from a predefined illuminance value, wherein the threshold is defined to determine whether an object is approaching the electronic device.

In accordance with another aspect of the present disclosure, an electronic device is provided. The electronic device includes a proximity sensor configured to emit light and to recognize an approach of an object by measuring a quantity of received light, an illuminance sensor configured to recognize a quantity of external light by measuring an illuminance value, and a sub control unit configured to control the proximity sensor and the illuminance sensor, to collect an illuminance value of light received through the illuminance sensor, and to change a threshold of a proximity sensing function, based on the collected illuminance value, if the collected illuminance value is different from a predefined illuminance value, wherein the threshold is defined to determine whether an object is approaching the electronic device, and a main control unit configured to transmit a sensor activation or inactivation signal to the sub control unit, and to perform the proximity sensing function according to object approach information received from the sub control unit.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a mobile electronic device according to an embodiment of the present disclosure.

FIG. 2 is a flow diagram illustrating a method for operating a proximity sensing function according to an embodiment of the present disclosure.

FIG. 3 is a block diagram illustrating a mobile electronic device according to an embodiment of the present disclosure.

FIG. 4 is a flow diagram illustrating a method for operating a proximity sensing function according to an embodiment of the present disclosure.

FIGS. 5 and 6 show an algorithm for setting the threshold of proximity sensing data according to an embodiment of the present disclosure.

The same reference numerals are used to represent the same elements throughout the drawings.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a signal” includes reference to one or more of such signals.

In this disclosure, the term “a proximity sensing function” refers to a function to automatically lock (or turn off) a touch screen so as to prevent a wrong operation due to any unexpected touch and thereby reduce power consumption when a user's face or ear approaches a mobile device having the touch screen, and to automatically unlock (or turn on) the touch screen when a user's face or ear becomes distant from the touch screen.

In this disclosure, the term “an illuminance sensing function” refers to a function to automatically adjust the brightness of the touch screen depending on the ambient illuminance environment, namely, to offer a clear screen in the light and offer a dim screen in a dark environment.

Technique disclosed herein may be applied to a variety of mobile devices such as a mobile phone, a smart phone, a tablet PC, a hand-held PC, a PMP (Portable Multimedia Player), a PDA (Personal Digital Assistant), and the like. The following description will be given on the assumption that technique to operate a proximity sensing function is a mobile device in which an illuminance sensor unit and a proximity sensor unit are formed of different chips.

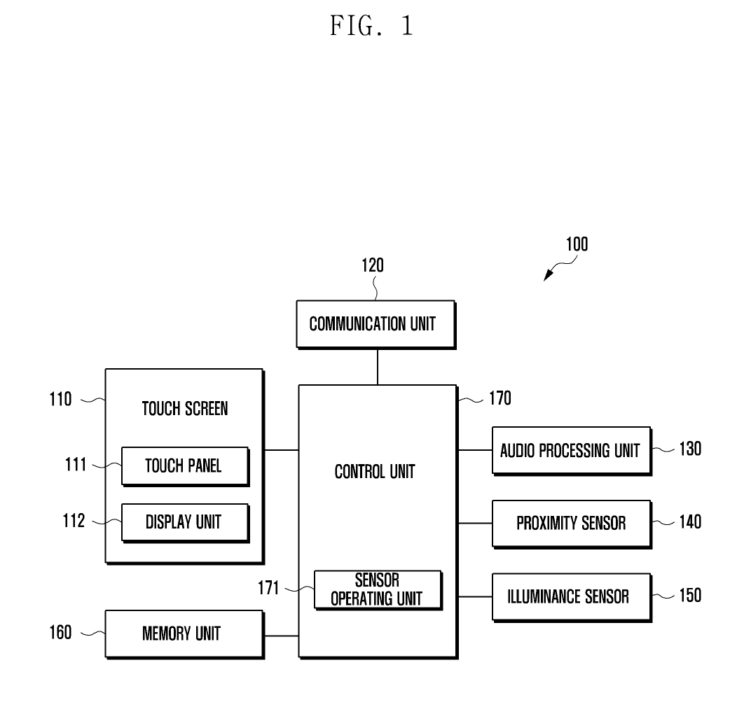

FIG. 1 is a block diagram illustrating a mobile electronic device according to an embodiment of the present disclosure.

Referring to FIG. 1, a mobile device 100 in this embodiment may include, but is not limited to, a touch screen 110 composed of a touch panel 111 and a display unit 112, a communication unit 120, an audio processing unit 130, a proximity sensor 140, an illuminance sensor 150, a memory unit 160, and a control unit 170.

The device 100 having the above-mentioned elements offers, when a request for activating a proximity sensing function is detected, a function to activate the illuminance sensor 150 and thereby measure an illuminance value (e.g., the quantity of light received through a light-receiving unit to be discussed below), a function to determine whether the measured illuminance value exceeds a predefined condition, and a function to change the threshold of the proximity sensing function based on the measured illuminance value.

The touch screen 110 displays a screen in response to or in connection with the execution of a user function, and detects a touch event associated with the control of such a user function. The touch panel 111 creates an analog signal (e.g., a touch event) in response to a user input (e.g., a user gesture) thereon, converts the analog signal into a digital signal through analog-to-digital conversion, and then transmits the digital signal to the control unit 170. Here, a touch event contains therein information about touch coordinates (X, Y). When such a touch event is received from the touch screen 110, the control unit 170 determines that a certain touch tool (e.g., a finger or a pen) is touched on the touch screen 110. Then if the touch event is not received any more from the touch screen 110, the control unit 170 determines that a touch is removed. Additionally, when touch coordinates are varied, the control unit 170 determines that a touch point is moved, and then calculates a variation of a touch position and a moving speed of a touch point in response to the movement of a touch point. Based on the above-mentioned touch coordinates, the removal of a touch, the movement of a touch point, the variation of a touch position, the moving speed of a touch point, and the like, the control unit 170 identifies a user gesture.

The display unit 112 displays various screens for the operation of the device, including various menus of the device. Namely, the display unit 112 may visually offer a variety of screens in connection with the use of the device 100, e.g., a home screen, a menu screen, a message creating screen, a call screen, a scheduler screen, a phonebook screen, a webpage display screen, and the like. The display unit 112 supports a landscape mode or a portrait mode, depending on a placed orientation or rotating direction of the device.

In this disclosure, the touch screen 110 may support a proximity sensing function for locking or unlocking the touch screen 110 depending on whether any object approaches the screen. Namely, in response to the approach of a certain object, the touch panel 111 and the display unit 112 may be turned off so as to prevent any unnecessary, unexpected operation and reduce power consumption. In contrast, if such an object becomes distant, the touch panel 111 and the display unit 112 may be turned on automatically and, without requiring any additional input, allow a user to use the device.

Although it will be described below that such a proximity sensing function is performed during a call function, this is exemplary only and not to be considered as a limitation. Alternatively, a proximity sensing function may be performed in connection with the execution of any other function of the device.

The communication unit 120 performs a communication function of the device. Namely, the communication unit 120 establishes a communication channel with any supportable mobile communication network and thereby performs a communication such as a voice communication, a video communication, and a data communication, but is not limited thereto. The communication unit 120 may include a Radio Frequency (RF) transmitter that up-converts the frequency of an outgoing signal and then amplifies the signal, an RF receiver that amplifies with low-noise an incoming signal and down-converts the frequency of the signal, and the like. The communication unit 120 may support transmission and reception of a call, a message, a messenger, etc. with any other device.

The audio processing unit 130 may include a speaker that outputs an audio signal created or decoded in the device, and a microphone that collects an audio signal in order to support a voice call, a video call, a voice recording, etc. and converts the audio signal into an electric signal. The audio processing unit 130 may be formed of codec (i.e., coder and decoder), which may include a data codec for processing packet data and an audio codec for processing an audio signal such as voice. Also, the audio processing unit 130 supports the output of sound effects or notifying or alerting sounds in response to any notification event.

The proximity sensor 140 detects an approaching object and transmits related information to the control unit 170. The proximity sensor 140 includes a light-emitting unit and a light-receiving unit. For example, the light-emitting unit may be formed of Infrared Light Emitting Diode (IR LED), and the light-receiving unit may be formed of a photodiode capable of detecting infrared light. This is, however, exemplary only and not to be considered as a limitation.

When a proximity sensing function is activated, the proximity sensor 140 detects the approach of an object. When the proximity sensor 140 is activated, the light-emitting unit emits light, which is reflected by an object. The light-receiving unit absorbs the reflected light. Then the light-receiving unit converts the absorbed light into an electric current and obtains a proximity sensing value from the electric current through an Analog-to-Digital Converter (ADC). This proximity sensing value is delivered to the control unit 170, which determines, based on the proximity sensing value, whether any object is approaching the electronic device.

The illuminance sensor 150 measures the intensity of illuminance or radiation and delivers an illuminance value to the control unit 170. The illuminance sensor 150 absorbs surrounding light (e.g., sunlight or indoor light), converts the absorbed light into an electric current, converts this electric current into an illuminance value through the ADC, and delivers the illuminance value to the control unit 170. The illuminance sensor 150 may be formed of, for example, but not limited to, a light-receiving device such as a photodiode that absorbs visible light, infrared light, etc. Here, illuminance refers to luminous flux per unit area. The lux is the unit of illuminance, and one lux is defined as the brightness on a surface perpendicular to the direction to a light source of one candlepower and located at a distance of one meter from the source. The illuminance sensor 150 may have a measuring range from one lux to hundreds of thousands lux. The illuminance sensor 150 may measure periodically, e.g., in a 0.2-0.5-second cycle, the surrounding illuminance. Meanwhile, the illuminance sensor 150 may be used for adjusting the brightness of a screen, depending on an illuminance state.

The proximity sensor 140 and the illuminance sensor 150 may be disposed at the front side of the device and near the touch screen 110. Further, the proximity sensor 140 and the illuminance sensor 150 may be formed of separate chips.

The memory unit 160 may store therein an operating system, various programs and applications, and data created in the device. Such data may include all kinds of data generated in connection with the execution of applications, created using the device, or received from the external entity (e.g., an external server, any other user device, etc.). Additionally, the memory unit 160 may store therein a user interface provided by the device and many types of setting information needed for performing functions of the device.

The control unit 170 controls the overall operation and internal signal flows of the device and performs a function of data processing. Further, the control unit 170 controls the supply of electric power from a battery to internal components. When electric power is supplied, the control unit 170 controls a booting procedure of the device and executes various programs stored in a program region of the memory unit 160 to perform a particular function of the device.

The control unit 170 may include a sensor operating unit 171, which controls a plurality of sensors equipped in the device in response to a user input or request for performing a particular function. Although FIG. 1 shows the proximity sensor 140 and the illuminance sensor 150, the device may further include inherently or optionally any other sensor such as a gesture sensor, a gyro sensor, a magnetic sensor, an acceleration sensor, a motion sensor, a biometric sensor, a temperature sensor, a humidity sensor, a pressure sensor, a gravity sensor, and the like.

The sensor operating unit 171 operates a proximity sensing function, based on sensing values transmitted periodically from the proximity sensor 140 or the illuminance sensor 150. For example, when a request for activating a proximity sensing function is detected, the sensor operating unit 171 stores an illuminance value, received periodically from the illuminance sensor 150, in a register thereof and also compares a current illuminance value with a predefined illuminance value to determine whether the current illuminance value exceeds the predefined illuminance value.

If it is determined that the current illuminance value exceeds the predefined value, the sensor operating unit 171 changes, based on the current illuminance value, the threshold of a proximity sensing function which is used for determining whether a certain object is approaching the electronic device. This threshold of a proximity sensing function may include the first threshold used for triggering a function to lock the touch screen and the second threshold used for triggering a function to unlock the touch screen. The threshold may be set based on a distance between the proximity sensor 140 and an object. The proximity sensing function is a particular function to detect the approach of a user, to execute a screen lock function in response to the detection of a user's approach, and to stop the screen lock function in response to no detection of a user's approach, thus preventing any undesired key input.

Namely, if a proximity sensing value measured through the proximity sensor 140 corresponds to the first threshold, the sensor operating unit 171 determines that any object (e.g., a user's face) approaches the touch screen, and then executes a screen lock (or turn-off) function. Thereafter, a proximity sensing value measured periodically corresponds to the second threshold, the sensor operating unit 171 determines that the object becomes distant from the touch screen, and then executes a screen unlock (or turn-on) function. The sensor operating unit 171 may determine, based on a hysteresis algorithm, whether a proximity sensing value corresponds to the threshold.

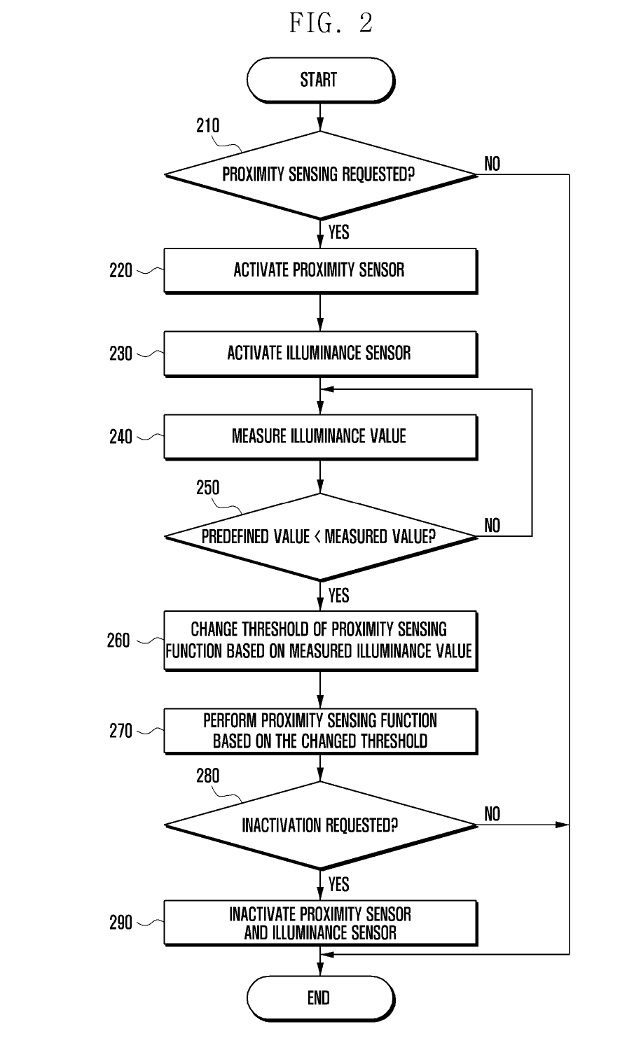

FIG. 2 is a flow diagram illustrating a method for operating a proximity sensing function according to an embodiment of the present disclosure.

Referring to FIGS. 1 and 2, at operation 210, the device 100 determines whether a request for activating a proximity sensing function is detected according to a user input or predefined schedule. For example, the device 100 may detect an input signal for activating a call transmitting or receiving function from the touch screen 110 or any other key. Namely, the device 100 may detect a signal for invoking a call application by receiving an input from a dial or phone key for an outgoing call or an input from a call or acceptance key for an incoming call.

If a request for activating the proximity sensing function is detected, the device 100 activates the proximity sensor 140 at operation 220. Then the device 100 activates the illuminance sensor 150 at operation 230 and measures an illuminance value of the quantity of light received by the illuminance sensor 150 at operation 240. Namely, the illuminance sensor 150 absorbs surrounding light (e.g., sunlight or indoor light), converts the absorbed light into an electric current, converts this electric current into an illuminance value through ADC, and delivers the illuminance value to the control unit 170.

At operation 250, the device 100 determines whether the measured illuminance value exceeds a predefined illuminance value. For example, the predefined illuminance value may be a measured value of the quantity of light absorbed through a light-receiving device without any light such as sunlight or indoor light in the ambient environment. For example, if the predefined illuminance value is set as a value measured in indoor light or dark environment, any case in which the measured illuminance value exceeds the predefined illuminance value may be regarded as the sunlight or external light environment having relatively higher quantity of light. Meanwhile, if the measured illuminance value does not exceed the predefined illuminance value, the device 100 may return to operation 240 and periodically measure an illuminance value. At this time, the measuring period of the illuminance sensor 150 may be set based on power consumption, for example, but not limited to, as several seconds or several minutes.

If it is determined that the measured illuminance value exceeds the predefined illuminance value, the device 100 changes at operation 260, based on the measured illuminance value, the threshold of the proximity sensing function to be used for determining whether a certain object is approaching the electronic device. As mentioned above, the threshold of the proximity sensing function may include the first threshold used for triggering a function to lock the touch screen 110 and the second threshold used for triggering a function to unlock the touch screen 110.

At operation 270, the device 100 executes the proximity sensing function on the basis of the changed threshold. For example, the device 100 may execute a screen lock (or turn-off) function when a user approaches the touch screen 110, and execute a screen unlock (or turn-on) function when a user becomes distant from the touch screen 110.

At operation 280, the device 100 determines whether a request for inactivating the proximity sensing function is detected. This request may be, for example, an input for disconnecting a call. If a request for inactivating the proximity sensing function is detected, the device 100 inactivates the proximity sensor 140 and the illuminance sensor 150 at operation 290.

Meanwhile, even after the threshold is changed, the device 100 may perform repeatedly the above-discussed process from operation 240. Since a conventional proximity sensing function has a fixed threshold defined at the time of manufacturing the device, it operates regardless of variation of ambient environment. In contrast, the proximity sensing function disclosed herein has a variable threshold depending on a real-time illuminance value and thus enhances the accuracy and reliability thereof.

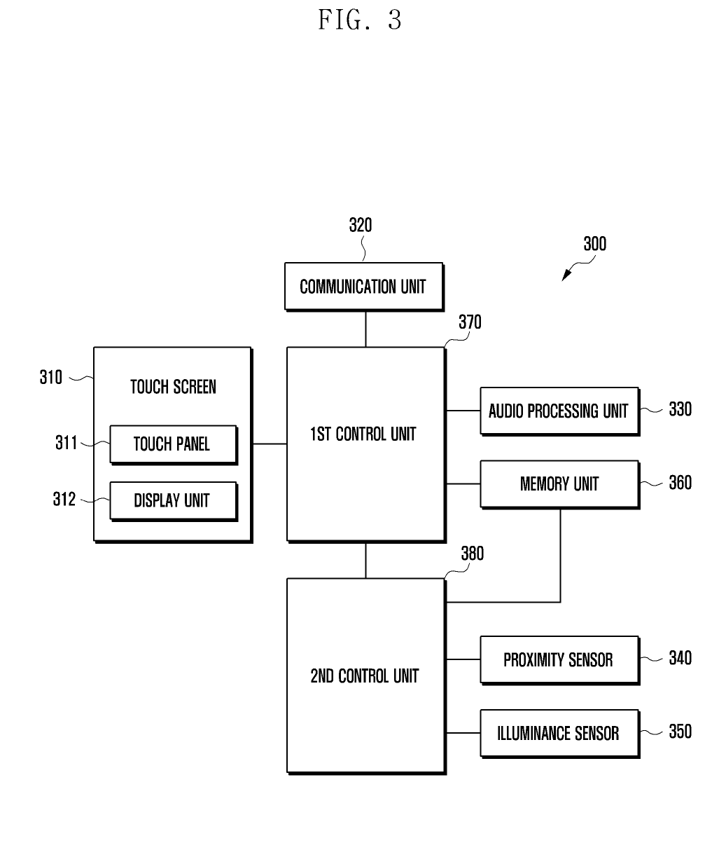

FIG. 3 is a block diagram illustrating a mobile electronic device according to an embodiment of the present disclosure.

Referring to FIG. 3, a mobile device 300 in this embodiment may include, but not limited to, a touch screen 310, a communication unit 320, an audio processing unit 330, a proximity sensor 340, an illuminance sensor 350, a memory unit 360, the first control unit 370, and the second control unit 380.

Each of the touch screen 310, the communication unit 320, the audio processing unit 330, the proximity sensor 340, the illuminance sensor 350, and the memory unit 360 in this embodiment has the same function as that of each of the touch screen 110, the communication unit 120, the audio processing unit 130, the proximity sensor 140, the illuminance sensor 150, and the memory unit 160 discussed above and shown in FIG. 1. So a detailed description regarding these elements will be omitted hereinafter.

The first control unit 370 (also referred to as a main control unit hereinafter) controls the overall operation and internal signal flows of the device and performs a function of data processing. For example, the first control unit 370 may be a Central Processing Unit (CPU), an application processor, etc. having much power consumption.

The first control unit 370 connected to the second control unit 380 detects a request for activating or inactivating a proximity sensing function and then transmits an interrupt signal to the second control unit 380. For example, the first control unit 370 transmits a sensor activation interrupt signal to the second control unit 380 in response to the execution of a call function, and transmits a sensor inactivation interrupt signal to the second control unit 380 in response to the stop of a call function.

The second control unit 380 (also referred to as a sub control unit hereinafter) is connected to the proximity sensor 340 and the illuminance sensor 350 and, in response to an interrupt signal from the first control unit 370, controls each of the proximity sensor 340 and the illuminance sensor 350. The second control unit 380 may be formed of a low-power processor such as a Micro Processor Unit (MPU), a Micro Control Unit (MCU), or the like.

Although not shown, the second control unit 380 may be further connected to any other sensor. Meanwhile, the second control unit 380 may control the sensors 340 and 350 when the first control unit 370 is in a sleep mode, and the first control unit 370 may control the sensors 340 and 350 in a wake mode.

In response to a sensor activation interrupt signal received from the first control unit 370, the second control unit 380 collects sensing information from the proximity sensor 340 and the illuminance sensor 350. Specifically, the second control unit 380 activates the proximity sensor 340 and the illuminance sensor 350 in response to the sensor activation interrupt signal. Then, when a request for activating a proximity sensing function is detected, the second control unit 380 stores an illuminance value, received periodically from the illuminance sensor 350, in a register thereof and also compares a current illuminance value with a predefined illuminance value to determine whether the current illuminance value exceeds the predefined illuminance value. If it is determined that the current illuminance value exceeds the predefined value, the second control unit 380 changes, based on the current illuminance value, the threshold of a proximity sensing function which is used for determining whether a certain object is approaching the electronic device. This threshold of a proximity sensing function may include the first threshold used for triggering a function to lock the touch screen and the second threshold used for triggering a function to unlock the touch screen. Here, the second control unit 380 may determine, based on a hysteresis algorithm, whether a proximity sensing value corresponds to the threshold.

After changing the threshold of the proximity sensing function, the second control unit 380 transmits, to the first control unit 370, object approach information based on a proximity sensing value collected through the proximity sensor 340. Then the first control unit 370 executes the proximity sensing function by controlling the touch screen 310 on the basis of the object approach information received from the second control unit 380.

Meanwhile, if a sensor inactivation interrupt signal is received from the first control unit 370, the second control unit 380 inactivates the proximity sensor 340 and the illuminance sensor 350.

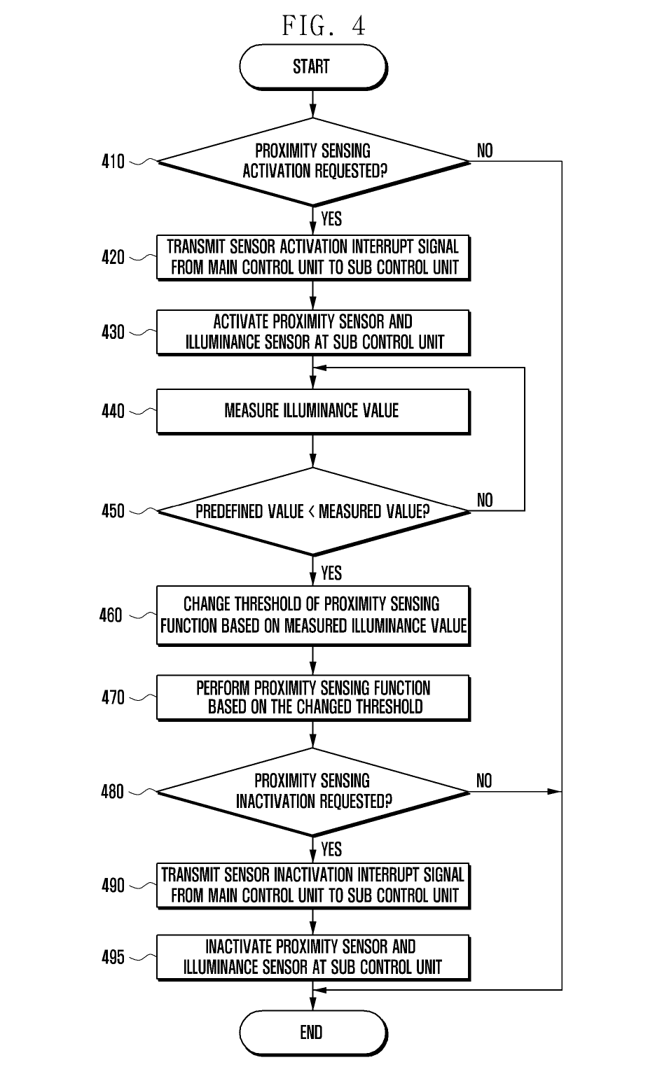

FIG. 4 is a flow diagram illustrating a method for operating a proximity sensing function according to an embodiment of the present disclosure.

Referring to FIGS. 3 and 4, at operation 410, a main control unit (i.e., the first control unit 370 in FIG. 3) determines whether a request for activating a proximity sensing function is detected according to a user input or predefined schedule. For example, this request may correspond to an input for invoking a call application or function. In response to a request for activating the proximity sensing function, the main control unit 370 transmits at operation 420 a sensor activation interrupt signal to a sub control unit (i.e., the second control unit 380 in FIG. 3). This sensor activation interrupt signal may be a signal for instructing the activation of at least one of the proximity sensor 340 and the illuminance sensor 350.

In response to the sensor activation interrupt signal, the sub control unit 380 activates the proximity sensor 340 and the illuminance sensor 350 at operation 430 and then measures an illuminance value of the quantity of light received by the illuminance sensor 350 at operation 440. At operation 450, the sub control unit 380 determines whether the measured illuminance value exceeds a predefined illuminance value. If it is determined that the measured illuminance value exceeds the predefined illuminance value, the sub control unit 380 changes at operation 460, based on the measured illuminance value, the threshold of the proximity sensing function to be used for determining whether a certain object is approaching the electronic device. Meanwhile, if the measured illuminance value does not exceed the predefined illuminance value, the sub control unit 380 may return to operation 440 and periodically measure an illuminance value.

At operation 470, the sub control unit 380 determines, based on the changed threshold, whether an object is approaching the electronic device, and transmits object approach information to the main control unit 370. Then the main control unit 370 executes the proximity sensing function by controlling the touch screen 310 on the basis of the object approach information. For example, the main control unit 370 may execute a screen lock (or turn-off) function when a user approaches the touch screen 310, and execute a screen unlock (or turn-on) function when a user becomes distant from the touch screen 310.

At operation 480, the main control unit 370 determines whether a request for inactivating the proximity sensing function is detected. This request may be, for example, an input for disconnecting a call. If a request for inactivating the proximity sensing function is detected, the main control unit 370 transmits a sensor inactivation signal to the sub control unit 380 at operation 490. Then, in response to this sensor inactivation signal, the sub control unit 380 inactivates the proximity sensor 340 and the illuminance sensor 350 at operation 495.

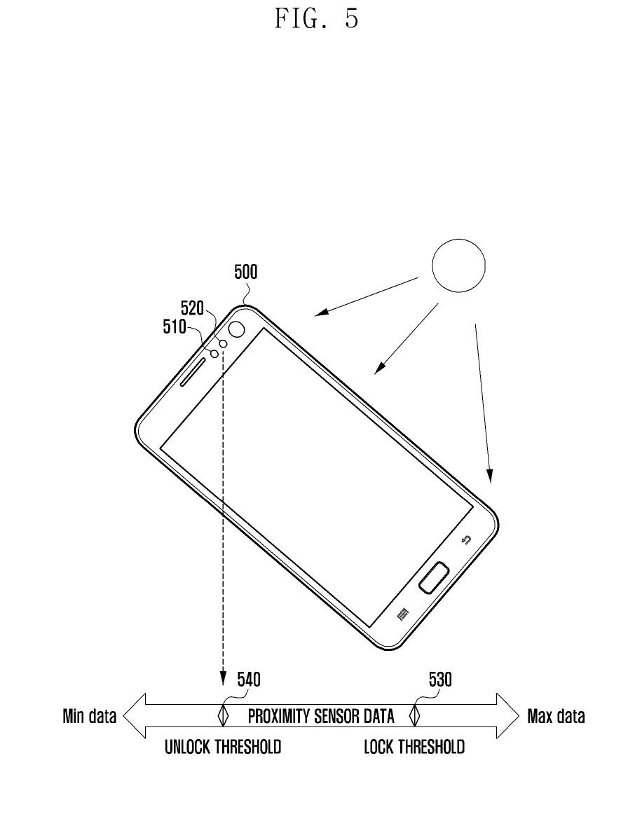

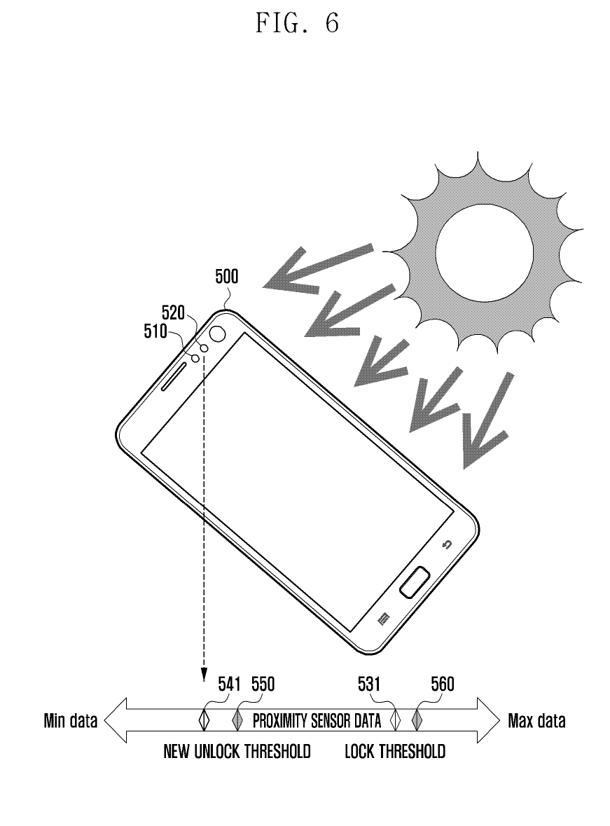

FIGS. 5 and 6 show an algorithm for setting the threshold of proximity sensing data according to an embodiment of the present disclosure.

Referring to FIGS. 5 and 6, a proximity sensor 510 and an illuminance sensor 520 may be disposed at an upper portion of the front side of a device 500. This is, however, exemplary only and not to be considered as a limitation. As discussed above, the proximity sensor 510 may be formed of a light-emitting unit and a light-receiving unit, and the illuminance sensor 520 may be formed of a light-receiving device.

The proximity sensor 510 and the illuminance sensor 520 may be activated when a specific application is invoked. For example, if a call application is invoked and thereby a call function is executed, the proximity sensor 510 and the illuminance sensor 520 may be activated to operate a proximity sensing function. Further, the device 500 may control the proximity sensor 510 to collect a proximity sensing value. At the same time, the device 500 may control the illuminance sensor 520 to collect an illuminance value. Here, a proximity sensing value depends on a distance between any approaching object and the front side of the device 500, and an illuminance value depends on the quantity of light in the ambient environment.

As shown in FIG. 5, a proximity sensing function may operate based on the threshold predefined for determining whether an object is approaching the electronic device. The threshold may be a default value defined at the time of manufacturing the device 500 or any other value changed and stored during the operation of a previous proximity sensing function.

Additionally, the threshold may include the first threshold 530 defined for triggering a screen lock function and the second threshold 540 defined for triggering a screen unlock function.

When a proximity sensor value reaches the first threshold 530, the device 500 performs a screen lock function by determining that an object (e.g., a user's face) approaches the touch screen of the device 500. In contrast, if a proximity sensor value reaches the second threshold 540, the device 500 performs a screen unlock function by determining that the object becomes distant from the touch screen.

Meanwhile, as shown in FIG. 6, the quantity of light received through the proximity sensor 510 may be increased due to much light in the ambient environment during the operation of the proximity sensing function. In this case, a proximity sensing value may fail to reach the second threshold 541 or undesirably exceed the first threshold 531, thus causing a wrong operation of the proximity sensing function.

Therefore, the device 500 measures the quantity of light through the illuminance sensor 520 and, based on an illuminance value of the measured quantity, changes the threshold of the proximity sensing function. For example, based on such an illuminance value, as shown in FIG. 6, the second threshold 541 defined for triggering a screen unlock function is changed to a new second threshold 550, and the first threshold 531 defined for triggering a screen lock function is changed to a new first threshold 560. Although FIG. 6 shows that both thresholds are changed together, in another embodiment only one of the first and second thresholds may be changed.

As fully discussed hereinbefore, an illuminance value may be sensitively varied according to the ambient environment. If the proximity sensing function operates in any environment directly exposed to external light, the proximity sensor may be subjected to much light due to such external light and this may often cause the degradation of accuracy and reliability of the proximity sensing function.

The device disclosed herein may enhance the accuracy and reliability of the proximity sensing function by changing the threshold of the proximity sensing function depending on a real-time illuminance value.

It will be appreciated that various embodiments of the present disclosure according to the claims and description in the specification can be realized in the form of hardware, software or a combination of hardware and software.

Any such software may be stored in a non-transitory computer readable storage medium. The non-transitory computer readable storage medium stores one or more programs (software modules), the one or more programs comprising instructions, which when executed by one or more processors in an electronic device, cause the electronic device to perform a method of the present disclosure.

Any such software may be stored in the form of volatile or non-volatile storage such as, for example, a storage device like a Read Only Memory (ROM), whether erasable or rewritable, or in the form of memory such as, for example, Random Access Memory (RAM), memory chips, device or integrated circuits or on an optically or magnetically readable medium such as, for example, a Compact Disk (CD), Digital Versatile Disc (DVD), magnetic disk or magnetic tape or the like. It will be appreciated that the storage devices and storage media are various embodiments of non-transitory machine-readable storage that are suitable for storing a program or programs comprising instructions that, when executed, implement various embodiments of the present disclosure. Accordingly, various embodiments provide a program comprising code for implementing apparatus or a method as claimed in any one of the claims of this specification and a non-transitory machine-readable storage storing such a program.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for operating a proximity sensing function of an electronic device including a touch screen, the method comprising:
detecting a request for activating the proximity sensing function;
measuring an illuminance value of light received by an illuminance sensor in response to the detected request; and
if the measured illuminance value is different from a predefined illuminance value, changing a threshold of the proximity sensing function, based on the measured illuminance value.

2. The method of claim 1, wherein the threshold includes a first threshold defined to determine that an object approaches the electronic device within a given distance, and a second threshold defined to determine that the object becomes distant from the electronic device out of the given distance, and
wherein the changing of the threshold includes changing at least one of the first and second thresholds.

3. The method of claim 1, wherein the changing of the threshold is performed when the measured illuminance value exceeds the predefined illuminance value.

4. The method of claim 1, wherein the detecting of the request includes detecting at least one of a request for invoking a call application, a request for dialing an outgoing call, and a request for connecting an incoming call.

5. The method of claim 1, wherein the proximity sensing function triggers a function to lock the touch screen of the electronic device when an object approaches the electronic device within a given distance and triggers a function to unlock the touch screen of the electronic device when the object becomes distant from the electronic device out of the given distance.

6. The method of claim 1, wherein the measuring of the illuminance value includes converting the light received by the illuminance sensor into an electric current and converting the electric current into the illuminance value through an analog-to-digital conversion.

7. The method of claim 1, wherein the changing of the threshold is performed using the illuminance value periodically measured through the illuminance sensor.

8. The method of claim 1, further comprising:
after the changing of the threshold of the proximity sensing function,
performing the proximity sensing function based on the changed threshold.

9. A method for operating a proximity sensing function of an electronic device, the method comprising:
detecting, at a main control unit, a request for activating the proximity sensing function;
transmitting, at the main control unit, a sensor activation interrupt signal to a sub control unit;
activating, at the sub control unit, an illuminance sensor in response to the sensor activation interrupt signal and collecting an illuminance value of light received by the illuminance sensor; and
if the collected illuminance value is different from a predefined illuminance value, changing, at the sub control unit, a threshold of the proximity sensing function, based on the collected illuminance value.

10. The method of claim 9, further comprising:
after the changing of the threshold,
determining, at the sub control unit, based on the changed threshold, whether an object is approaching the electronic device;
transmitting, at the sub control unit, object approach information to the main control unit; and
performing, at the main control unit, the proximity sensing function according to the object approach information.

11. An electronic device comprising:
a proximity sensor configured to emit light and to recognize an approach of an object by measuring a quantity of received light;
an illuminance sensor configured to recognize a quantity of external light by measuring an illuminance value; and
a control unit configured to detect a request for activating a proximity sensing function and, based on the measured illuminance value, to change a threshold of the proximity sensing function if the measured illuminance value is different from a predefined illuminance value.

12. The electronic device of claim 11, wherein the control unit is further configured to change at least one of a first threshold defined to determine that the object approaches the electronic device within a given distance, and a second threshold defined to determine that the object becomes distant from the electronic device out of the given distance.

13. The electronic device of claim 11, wherein the control unit is further configured to change the threshold when the measured illuminance value exceeds the predefined illuminance value.

14. The electronic device of claim 11, wherein the proximity sensing function triggers a function to lock a touch screen of the electronic device when the object approaches the electronic device within a given distance and triggers a function to unlock the touch screen of the electronic device when the object becomes distant from the electronic device out of the given distance.

15. The electronic device of claim 11, wherein the control unit is further configured to change the threshold by periodically measuring the illuminance value through the illuminance sensor.

16. The electronic device of claim 11, wherein the control unit is further configured to compare a proximity sensing value collected through the proximity sensor with the changed threshold so as to determine whether the object is approaching the electronic device, and to perform the proximity sensing function depending on whether the object is approaching the electronic device.

17. An electronic device comprising:
a proximity sensor configured to emit light and to recognize an approach of an object by measuring a quantity of received light;
an illuminance sensor configured to recognize a quantity of external light by measuring an illuminance value; and
a sub control unit configured to control the proximity sensor and the illuminance sensor, to collect an illuminance value of light received through the illuminance sensor, and to change a threshold of a proximity sensing function, based on the collected illuminance value, if the collected illuminance value is different from a predefined illuminance value, wherein the threshold is defined to determine whether the object is approaching the electronic device; and
a main control unit configured to transmit a sensor activation or inactivation signal to the sub control unit, and to perform the proximity sensing function according to object approach information received from the sub control unit.

18. The electronic device of claim 17, wherein the main control unit is further configured to determine whether a request for activating the proximity sensing function is detected according to a user input or a predefined schedule.

19. A non-transitory computer-readable storage medium storing instructions that, when executed by at least one processor, cause the at least one processor to perform the method of claim 1.

20. A non-transitory computer-readable storage medium storing instructions that, when executed by at least one processor, cause the at least one processor to perform the method of claim 9.
